(19) United States
(12) Patent Application Publication
(10) Pub. No.: US 2025/0154827 A1
(43) Pub. Date: May 15, 2025

(54) Gate Protecting Device

(71) Applicant: Ayla Jade Lawson, Brenham, TX (US)

(72) Inventor: Ayla Jade Lawson, Brenham, TX (US)

(21) Appl. No.: 18/946,859

(22) Filed: Nov. 13, 2024

Related U.S. Application Data
(60) Provisional application No. 63/598,425, filed on Nov. 13, 2023.

(51) Int. Cl. E06B 11/02

(52) U.S. Cl. CPC E06B 11/02

(57) ABSTRACT

A gate protecting device is an apparatus that is used to prevent a gate from sagging while the gate is closed against its gate post. The apparatus includes a gate-resting plate, a gate-receiving plate, a gate-stopping plate, a length-adjustable arm, and an elongated mounting plate. When a gate is being swung closed, the gate initially engages the gate-receiving plate, which is a ramp that guides the gate onto the gate-resting plate. The gate-stopping plate is used to halt a gate's momentum after the gate has been guided onto the gate-resting plate. The length-adjustable arm is used to adjust an offset distance between a gate and a gate post. The elongated mounting plate secures the apparatus along a gate post.

The current application claims a priority to the U.S. provisional patent application Ser. No. 63/598,425 filed on Nov. 13, 2023.

### FIELD OF THE INVENTION

The present invention relates to a gate protecting device. More specifically, the present invention is a gate saving device that may be installed to the bottom end of a preexisting gate to prevent sagging of the gate and enable easier axial motion of the gate around the gate pole without scratching on the ground.

### BACKGROUND OF THE INVENTION

Farms and ranches typically have many livestock gates (rail field gates, farm gates, etc.), that are installed to control and confine livestock movement. These gates over time can sag and scrape along the ground making them difficult to operate and close. Further, this can cause the gate posts to also sag and even break. Furthermore, the gates can also be forced beyond the closed position putting undue mechanical stress on the hinges and gate posts.

An objective of the present invention is to provide users with a protective device that can prevent sagging of such farm gates. To accomplish this, a gate protective device is integrated between the actual gate and the gate pole, such that easier axial motion of the gate along the gate pole may be achieved without the gate touching or scratching anywhere on the ground. The present invention further helps in resting the gate at an even level above the ground without putting too much pressure on the hinges or fasteners connecting the gate to the gate poles. Additionally, the present invention comprises a stopping tab that prevents overshooting of the gate beyond a certain level as well as a gap that allows the protruding tab of certain gates to pass through without hindering the smooth opening and closing action of the gate. Thus, the present invention is a simple yet user-friendly and cost-efficient addition to gates that increases the durability and ease of operation of the gates.

### SUMMARY OF THE INVENTION

The present invention is intended to provide users with a protective device that can prevent sagging of farm gates. To accomplish this, a gate protective device is integrated between the actual gate and the gate pole, such that easier axial motion of the gate along the gate pole is achieved without the gate touching or scratching anywhere on the ground. The present invention further helps in resting the gate at an even level above the ground without putting too much pressure on the hinges or fasteners connecting the gate to the gate poles. Additionally, the present invention comprises a stop tab that prevents overshooting of the gate beyond a certain level as well as a gap that allows the protruding section of certain gates to pass through without hindering the smooth opening and closing action of the gate. Thus, the present invention is a simple yet user-friendly and cost-efficient addition to farm gates that increases the durability and ease of operation of the gates.

### BRIEF DESCRIPTION OF THE DRAWINGS

FIG. 1 is a perspective view of a preferred embodiment for the present invention.

FIG. 2 is a side view thereof.

FIG. 3 is a perspective view thereof showing the gate-receiving plate in one direction.

FIG. 4 is a perspective view thereof showing the gate-receiving plate in the opposite direction.

FIG. 5 is a perspective view thereof showing the length-adjustable arm in a retracted form.

FIG. 6 is a perspective view thereof showing the length-adjustable arm in an extended form.

FIG. 7 is a top-front-left perspective view of an alternate embodiment of the present invention.

FIG. 8 is a bottom-rear-right perspective view thereof.

FIG. 9 is a bottom-rear-left perspective view thereof.

FIG. 10 is a top-rear-right perspective view thereof.

FIG. 11 is a front elevational view thereof.

FIG. 12 is a rear elevational view thereof.

FIG. 13 is a left-side elevational view thereof.

FIG. 14 is a right-side elevational view thereof.

FIG. 15 is a top plan view thereof.

FIG. 16 is a bottom plan view thereof.

### DETAILED DESCRIPTION OF THE INVENTION

All illustrations of the drawings are for the purpose of describing selected versions of the present invention and are not intended to limit the scope of the present invention.

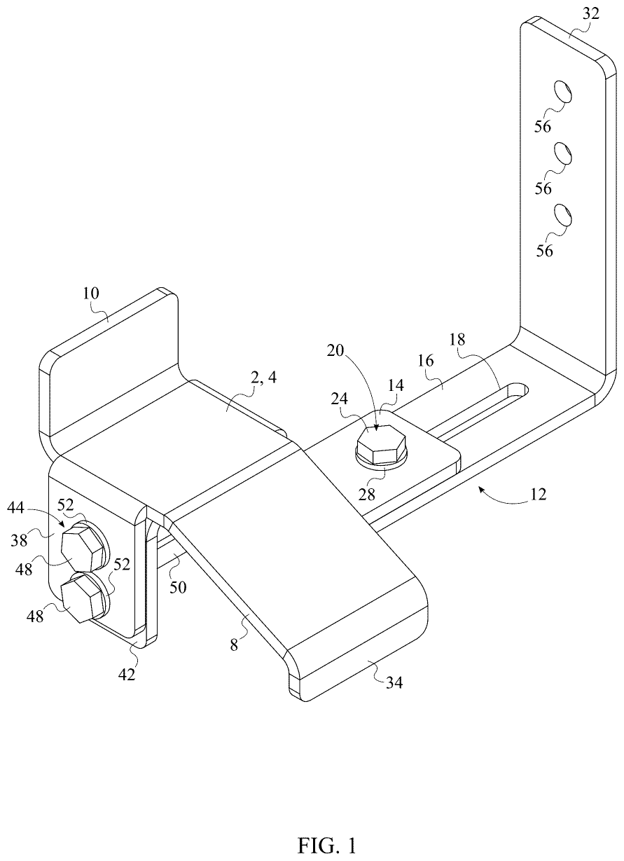

The present invention is a gate protection device that prevents a gate from sagging while the gate is closed against its gate post. The present invention consequently prevents a gate post from being damaged due to a gate's weight and consequently prevents the gate from being scratched up by scraping against the ground. To accomplish this, the present invention operatively couples a gate post and a gate in such a way that resting the gate on the present invention allows a user to keep the gate at a sufficient height above the ground. Thus, the present invention comprises a gate-resting plate 2, a gate-receiving plate 8, a gate-stopping plate 10, a length-adjustable arm 12, and an elongated mounting plate 32, which are shown in FIGS. 1 through 6. The gate-resting plate 2 allows a gate to rest upon the present invention after the gate is closed and is engaged to the present invention. The gate-receiving plate 8 is a kind of ramp guiding a gate upward to the gate-resting plate 2 as the gate engages the present invention. The gate-stopping plate 10 is used to stop a gate's momentum after the gate is closed and is engaged to the present invention. The length-adjustable arm 12 allows the present invention to adjust the distance between a gate post and an engagement point between a gate, the gate-resting plate 2, the gate-receiving plate 8, and the gate-stopping plate 10. The elongated mounting plate 32 allows the present invention to be affixed to a gate post.

The general configuration of the aforementioned components allows the present invention to efficiently and effectively to receive, situate, and secure a gate in place against a gate post. The gate-receiving plate 8 is connected adjacent to the gate-resting plate 2 and is positioned at an obtuse angle with the gate-resting plate 2, which allows a gate to engage the present invention by sliding up the gate-receiving plate 8 towards the gate-resting plate 2. The gate-receiving plate 8 is oriented away from a top plate face 4 of the gate-resting plate 2 so that the gate-receiving plate 8 is oriented in a downward direction and can consequently receive a sagging gate. The gate-stopping plate 10 is connected adjacent to the gate-resting plate 2, opposite to the gate-receiving plate 8, and is positioned perpendicular to the gate-resting plate 2, which allows a gate's momentum to be absorbed by the gate-stopping plate 10 after sliding onto the gate-resting plate 2. The gate-stopping plate 10 is oriented away from a bottom plate face 6 of the gate-resting plate 2 so that the gate-stopping plate 10 is oriented in an upward direction and can consequently prevent a gate from sliding off the gate-resting plate 2. The bottom plate face 6 is terminally mounted to the length-adjustable arm 12, and the elongated mounting plate 32 is terminally connected to the length-adjustable arm 12, opposite to the gate-resting plate 2, which allows the length-adjustable arm 12 to structurally secure the elongated mounting plate 32 to the rest of the present invention while still allowing a user to adjust a distance between the elongated mounting plate 32 and the rest of the present invention. The length-adjustable arm 12 is positioned parallel to the gate-receiving plate 8 and the gate-stopping plate 10 so that the length-adjustable arm 12 and the elongated mounting plate 32 do not mechanically interfere with a gate's motion as the gate is closed and engages with the gate-receiving plate 8, the gate-resting plate 2, and the gate-stopping plate 10. The elongated mounting plate 32 is positioned perpendicular to the length-adjustable arm 12 so that the elongated mounting plate 32 is aligned along a gate post and can better secure the present invention to the gate post.

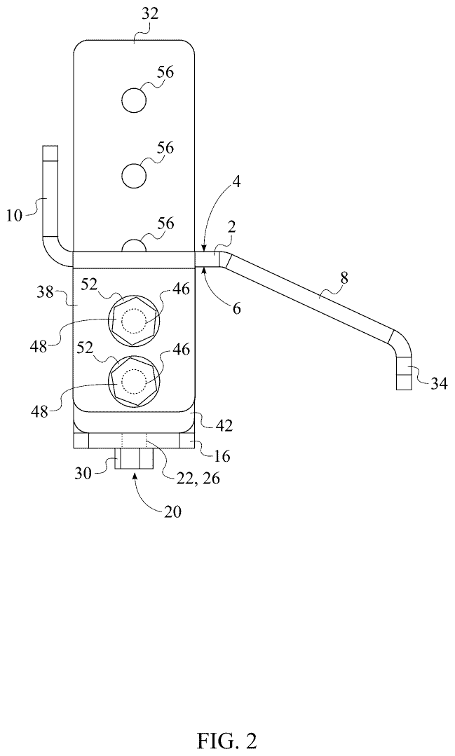

As can be seen in FIGS. 1 and 2, the present invention may further comprise an overhang tab 34, which prevents a gate from going underneath the gate-receiving plate 8. Thus, the overhang tab 34 is connected adjacent to the gate-receiving plate 8, opposite to the gate-resting plate 2, because the overhang tab 34 is the first component of the present invention to engage a gate as the gate is being closed. The overhang tab 34 is positioned perpendicular to the gate-resting plate 2 and is oriented away from the top plate face 4 so that the overhang tab 34 extends as far in a downwards direction as possible to better prevent a gate from going underneath the gate-receiving plate 8 and create a hitch in the gate's movement to engage the present invention.

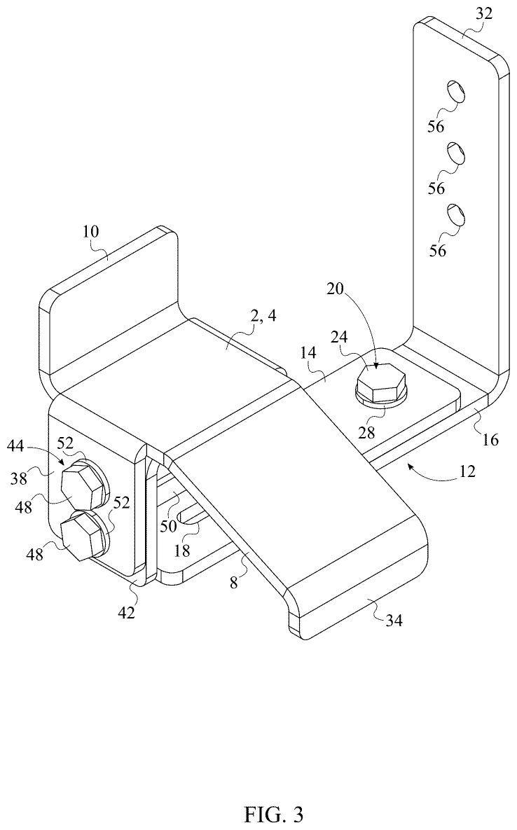

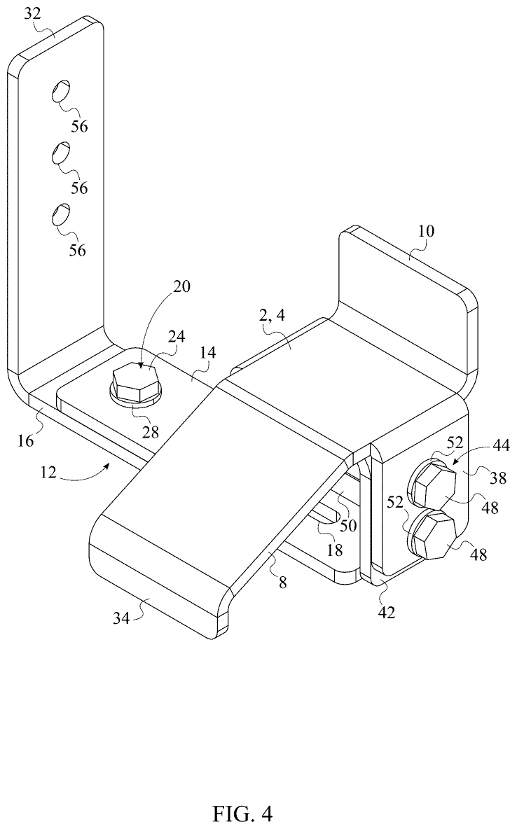

As can be seen in FIGS. 3 and 4, the present invention may further comprise a first wing plate 38, a second wing plate 40, a U-shaped fitting 42, and a plurality of orientation-adjustment fasteners 44, which are used to orient, attach, detach, reorient, and reattach the gate-receiving plate 8, the gate-resting plate 2, and the gate-stopping plate 10 in relation to the length-adjustable arm 12 because one gate can be configured to swing close in one direction (i.e., as shown in FIG. 3) and because another gate can be configured to swing close in an opposite direction (i.e., as shown in FIG. 4). The first wing plate 38 is connected adjacent to the gate-resting plate 2, and the second wing plate 40 is connected adjacent to the gate-resting plate 2, opposite to the first wing plate 38, which creates a space confined by the first wing plate 38, the second wing plate 40, and the gate-resting plate 2 to receive the U-shaped fitting 42. In order to create this space, the first wing plate 38 and the second wing plate 40 are positioned perpendicular to the gate-resting plate 2 and are oriented away from the top plate face 4. The U-shaped fitting 42 is terminally connected to the length-adjustable arm 12, opposite to the elongated mounting plate 32, which allows the length-adjustable arm 12 to readily attach to the gate-resting plate 2, the gate-receiving plate 8, and the gate-stopping plate 10 with the U-shaped fitting 42 or allows the length-adjustable arm 12 to readily detach from the gate-resting plate 2, the gate-receiving plate 8, and the gate-stopping plate 10 with the U-shaped fitting 42. The U-shaped fitting 42 is sized to slidably fit into this space confined by the first wing plate 38, the second wing plate 40, and the gate-resting plate 2 and can consequently be attached in between the first wing plate 38 and the second wing plate 40 by the plurality of orientation-adjustment fasteners 44. The plurality of orientation-adjustment fasteners 44 is positioned offset amongst each other in order to evenly support the U-shaped fitting 42 in between the first wing plate 38 and the second wing plate 40.

Each of the plurality of orientation-adjustment fasteners 44 may comprise an orientation-adjustment hole 46, an orientation-adjustment head 48, an orientation-adjustment male-threaded shaft 50, an orientation-adjustment washer 52, and an orientation-adjustment female-threaded nut 54, which allows the U-shaped fitting 42 to readily attach in between the first wing plate 38 and the second wing plate 40 and allows the U-shaped fitting 42 to readily detach from the first wing plate 38 and the second wing plate 40. The orientation-adjustment hole 46 traverses normal through the first wing plate 38, the U-shaped fitting 42, and the second wing plate 40 so that the orientation-adjustment male-threaded shaft 50 can be positioned through the orientation-adjustment washer 52 and the orientation-adjustment hole 46. The orientation-adjustment head 48 is terminally connected to the orientation-adjustment male-threaded shaft 50, while the orientation-adjustment female-threaded nut 54 is terminally engaged to the orientation-adjustment male-threaded shaft 50, offset from the orientation-adjustment head 48, which allows each of the plurality orientation-adjustment fasteners 44 to compressively secure the first wing plate 38, the second wing plate 40, and the U-shaped fitting 42 together. In one configuration where the gate-receiving plate 8, the gate-resting plate 2, and the gate-stopping plate 10 are oriented in one direction shown in FIG. 3, the orientation-adjustment washer 52 is pressed against the first wing plate 38 by the orientation-adjustment head 48, while the orientation-adjustment female-threaded nut 54 is pressed against the second wing plate 40. In another configuration where the gate-receiving plate 8, the gate-resting plate 2, and the gate-stopping plate 10 are oriented in an opposite direction shown in FIG. 4, the orientation-adjustment washer 52 is pressed against the second wing plate 40 by the orientation-adjustment head 48, and the orientation-adjustment female-threaded nut 54 being pressed against the first wing plate 38.

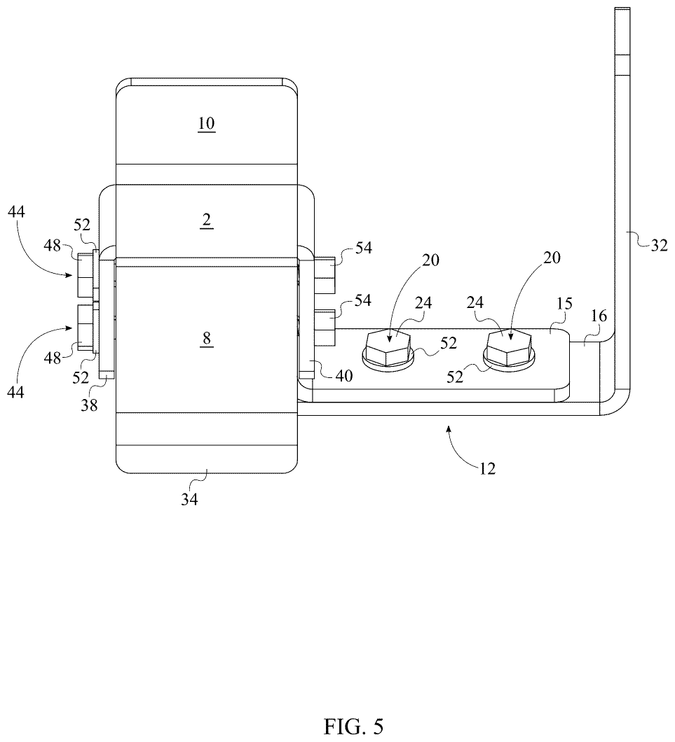

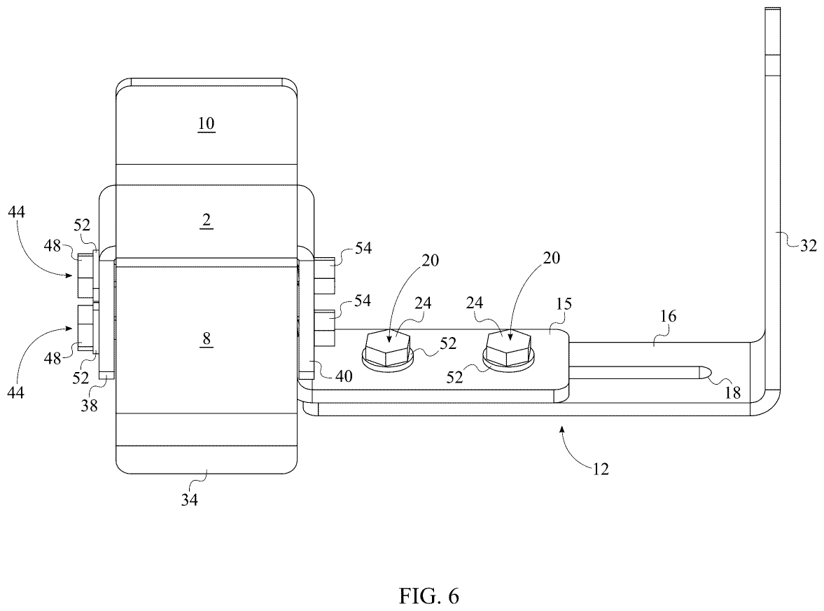

As can be seen in FIGS. 5 and 6, the length-adjustable arm 12 may comprise a proximal arm piece 12, a distal arm piece 16, a fastener-receiving slot 18, and a plurality of length-adjustment fasteners 20, which allow the length-adjustable arm 12 to extend and retract in a telescopic nature. The bottom plate face 6 is terminally mounted to the proximal arm piece 12, offset from the distal arm piece 16, and the elongated mounting plate 32 is terminally connected to the distal arm piece 16, offset from the proximal arm piece 12, so that a distance between the elongated mounting plate 32 and a combination of the gate-receiving plate 8, the gate-resting plate 2, and the gate-stopping plate 10 can be adjusted by a user. As an example shown in FIG. 5, if a gate is too close to a gate pole, then a user can shorten the length-adjustable arm 12 until the gate is able to properly engage the gate-receiving plate 8, the gate-resting plate 2, and the gate-stopping plate 10. As another example shown in FIG. 6, if a gate is too far from a gate pole, then a user can lengthen the length-adjustable arm 12 until the gate is able to properly engage the gate-receiving plate 8, the gate-resting plate 2, and the gate-stopping plate 10. Moreover, the fastener-receiving slot 18 traverses normal through the distal arm piece 16 and is positioned along the distal arm piece 16, and the plurality of length-adjustment fasteners 20 is mounted through and is attached into the fastener-receiving slot 18, which allows the plurality of length-adjustment fasteners 20 to attach at any point along the fastener-receiving slot 18 and consequently allows the proximal arm piece 12 and the distal arm piece 16 to slide, lock, unlock, re-slide, and re-lock in order to adjust an overall length of the length-adjustable arm 12.

Each of the plurality of length-adjustment fasteners 20 may comprise a length-adjustment hole 22, a length-adjustment head 24, a length-adjustment male-threaded shaft 26, a length-adjustment washer 28, and a length-adjustment female-threaded nut 30, which specify how the proximal arm piece 12 and the distal arm piece 16 are able to readily attach and detach from each other. The length-adjustment hole 22 traverses normal through the proximal arm piece 12 so that the length-adjustment male-threaded shaft 26 can be positioned through the length-adjustment washer 28, the length-adjustment hole 22, and the fastener-receiving slot 18. The length-adjustment head 24 is terminally connected to the length-adjustment male-threaded shaft 26, while the length-adjustment female-threaded nut 30 is terminally engaged to the length-adjustment male-threaded shaft 26, offset from the length-adjustment head 24, which allows each of the plurality length-adjustment fasteners 20 to compressively secure the proximal arm piece 12 and the distal arm piece 16 together. More specifically, the length-adjustment washer 28 is pressed against the proximal arm piece 12 by the length-adjustment head 24, while the length-adjustment female-threaded nut 30 is pressed against the distal arm piece 16.

As can be seen in FIGS. 1 and 2, the present invention may further comprise a plurality of post-mounting features 56, which are used to mount the present invention to a gate post. The plurality of post-mounting features 56 is integrated along the elongated mounting plate 32, which allows the elongated mounting plate 32 to evenly support the present invention along a gate post. The plurality of post-mounting features 56 is preferably a plurality of fastener-receiving holes (e.g., each fastener-receiving hole would receive a corresponding bolt or a corresponding screw that attached into the gate post).

### Supplemental Description

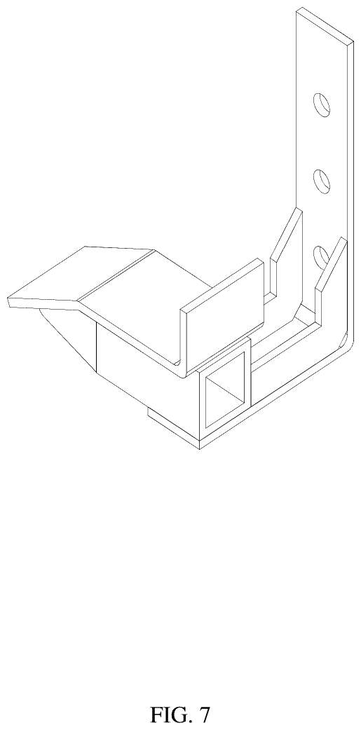

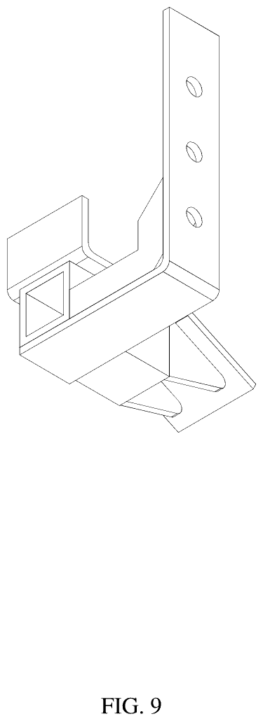

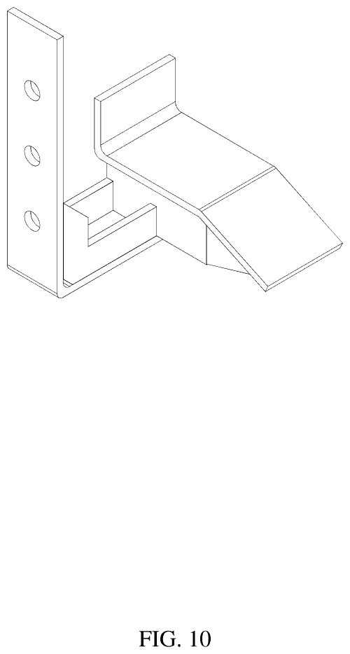

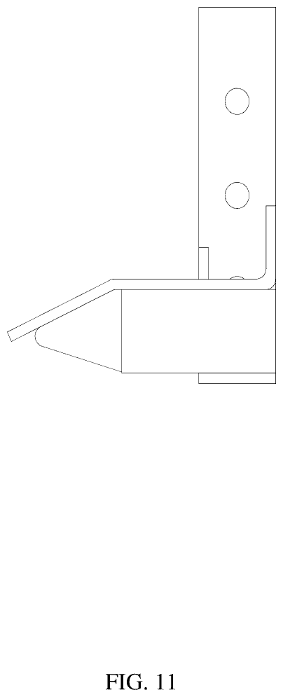

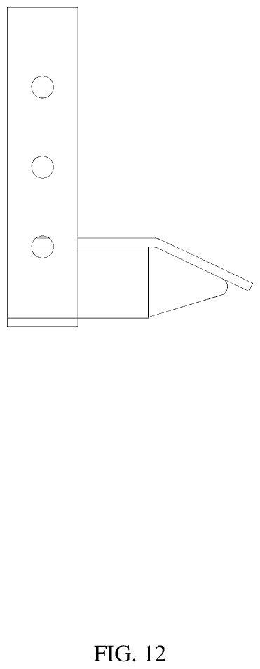

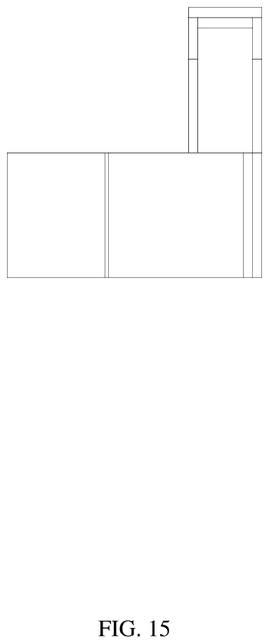

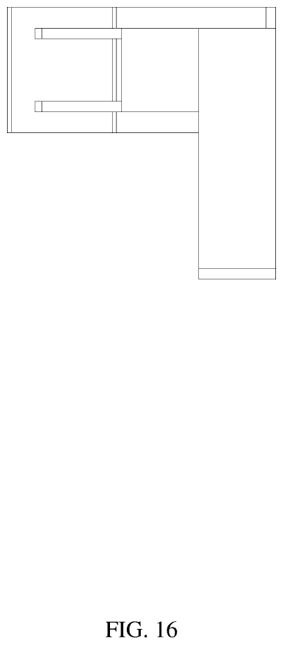

In reference to FIG. 7 through FIG. 16, the present invention is a protective gate device. It is an objective of the present invention to prevent sagging of gates and damage to the gate posts due to the weight of the gate as well as prevent subsequent scratching of the gate on the ground. To accomplish this, a gate protective device is integrated between the gate post and the gate, such that resting the gate on to the gate protective device enables the users to keep the gate a height sufficiently above the ground.

The following description is in reference to FIG. 7 through FIG. 16. According to a preferred embodiment, the present invention comprises a post attachment piece, a gate support structure, a plurality of support brackets, and a base support structure. The post attachment piece is the piece that attaches the present invention to the gate post. As seen in FIG. 7 through FIG. 10, the post attachment piece is an L-shaped structure that forms an integral connecting piece of the present invention. Accordingly, the post attachment piece comprises a first section and a second section, wherein the first section is positioned normally to the second section. More specifically, the first section is the vertical section that gets attached to a gate post. To accomplish this, a plurality of holes traverse through the first section to enable fasteners to pass through and connect the post attachment piece to the gate post. The first section continuously extends to the second section along the bottom end of the first section. The second section forms the base on which the rest of the components of the present invention are mounted. In other words, the second section forms the horizontal portion of the L-shaped post attachment piece. In order to provide enough support and strength to the present invention, a plurality of support brackets is mounted between the first section and the second section.

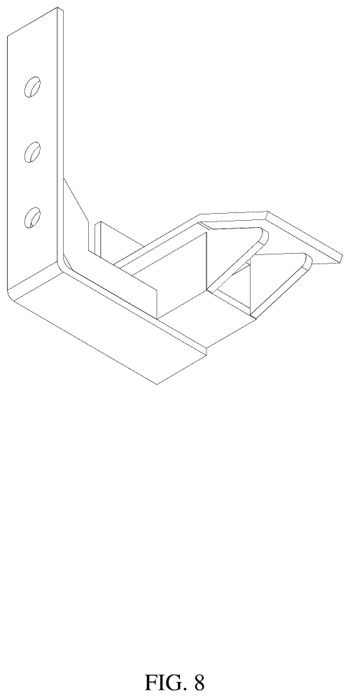

According to the preferred embodiment, the base support structure is mounted onto the second section, and the gate support structure is mounted on top of the base support structure. This is so that the gate support structure rests at a sufficient height above the ground. In other words, the base support structure provides the necessary height or lift for the gate above the ground so as to prevent sagging and scratching on the ground. Preferably, the base support structure is oriented normally to the first section and the second section, and the base support structure has a specific shape and dimensions to house the gate support structure on top. As seen in FIG. 7 and FIG. 8, the base support structure is a hollow rectangular structure with two triangular sections mounted on to one of the terminal ends of the rectangular structure. The triangular structure provides support for the inclined section of the gate support structure. The base support structure is made hollow such that the invention may be kept as light as possible, and the device does not pose more weight on the gate post.

As seen in FIG. 7 through FIG. 12, the gate support structure comprises a riser ramp, a gate rest region, and a stop tab. Preferably, the gate rest region is mounted between the riser ramp and the stop tab. More specifically, the riser ramp is provided so that the user may easily raise the gate from adjacent to the ground and place the gate on top of the gate rest region. Accordingly, the riser ramp is angularly offset from the gate rest region. In other words, the riser ramp is a ramp like structure with a small slope extending from the ground region towards the gate rest region. Further, the dimensions and orientation of the gate rest region are provided in such a way that there is enough space to rest a width of the gate. In order to prevent overshooting of the gate while the user is raising and placing the gate on the gate rest region, the stop tab is provided. Preferably, the stop tab extends away from the gate rest region in a direction opposite to second section of post attachment piece. In other words, the stop tab is a vertical piece attached terminally to the gate rest region opposite the riser ramp. Preferably, the post attachment piece, the gate support structure, and the support brackets are made of a sturdy material such as a metal. However, any other material that is known to one of ordinary skill in the art may be used, as long as the objectives of the present invention are fulfilled.

It should be noted that the present invention may comprise a plurality of fasteners for connecting and securing the post attachment piece to an external gate post. Preferably, the plurality of fasteners includes nuts and bolts or screws. However, any other fastening techniques that are known to one of ordinary skill in the art may be used, as long as the intents of the present invention are not altered.

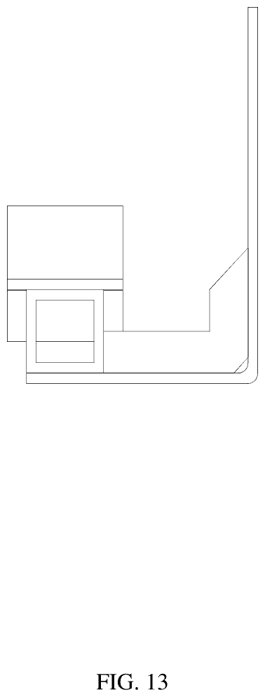

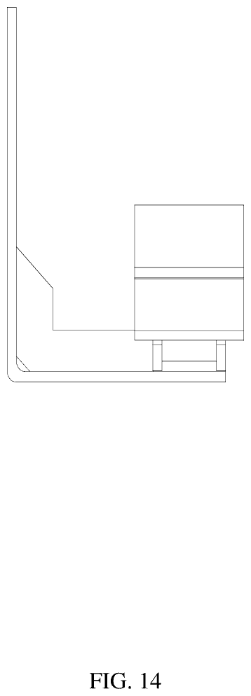

As seen in FIG. 13 and FIG. 14, a tab gap is provided between the plurality of support brackets and the gate support structure. This is because certain gates have protruding tab like structures and the tab gap between the support brackets and the gate resting region allows for those tabs to pass through and does not restrict the swing or axial movement of the gate. Thus, the present invention is a simple yet user-friendly and cost-efficient addition to gates that increases the durability and ease of operation of the gates.

Although the invention has been explained in relation to its preferred embodiment, it is to be understood that many other possible modifications and variations can be made without departing from the spirit and scope of the invention as hereinafter claimed.

What is claimed is:

1. A gate protecting device comprising:
a gate-resting plate;
a gate-receiving plate;
a gate-stopping plate;
a length-adjustable arm;
an elongated mounting plate;
the gate-resting plate comprising a top plate face and a bottom plate face;
the gate-receiving plate being connected adjacent to the gate-resting plate;
the gate-receiving plate being positioned at an obtuse angle with the gate-resting plate;
the gate-receiving plate being oriented away from the top plate face;
the gate-stopping plate being connected adjacent to the gate-resting plate, opposite to the gate-receiving plate;
the gate-stopping plate being positioned perpendicular to the gate-resting plate;
the gate-stopping plate being oriented away from the bottom plate face;
the bottom plate face being terminally mounted to the length-adjustable arm;
the elongated mounting plate being terminally connected to the length-adjustable arm, opposite to the gate-resting plate;
the length-adjustable arm being positioned parallel to the gate-receiving plate and the gate-stopping plate; and
the elongated mounting plate being positioned perpendicular to the length-adjustable arm.

2. The gate protecting device as claimed in claim 1 comprising:
an overhang tab;
the overhang tab being connected adjacent to the gate-receiving plate, opposite to the gate-resting plate;
the overhang tab being positioned perpendicular to the gate-resting plate; and
the overhang tab being oriented away from the top plate face.

3. The gate protecting device as claimed in claim 1 comprising:
a first wing plate;
a second wing plate;
a U-shaped fitting;
a plurality of orientation-adjustment fasteners;
the first wing plate being connected adjacent to the gate-resting plate;
the second wing plate being connected adjacent to the gate-resting plate, opposite to the first wing plate;
the first wing plate and the second wing plate being positioned perpendicular to the gate-resting plate;
the first wing plate and the second wing plate being oriented away from the top plate face;
the U-shaped fitting being terminally connected to the length-adjustable arm, opposite to the elongated mounting plate;
the U-shaped fitting being sized to slidably fit into a space confined by the first wing plate, the second wing plate, and the gate-resting plate;
the U-shaped fitting being attached in between the first wing plate and the second wing plate by the plurality of orientation-adjustment fasteners; and
the plurality of orientation-adjustment fasteners being positioned offset amongst each other.

4. The gate protecting device as claimed in claim 3 comprising:
each of the plurality of orientation-adjustment fasteners comprising an orientation-adjustment hole, an orientation-adjustment head, an orientation-adjustment male-threaded shaft, an orientation-adjustment washer, and an orientation-adjustment female-threaded nut;
the orientation-adjustment hole traversing normal through the first wing plate, the U-shaped fitting, and the second wing plate;
the orientation-adjustment male-threaded shaft being positioned through the orientation-adjustment washer and the orientation-adjustment hole;
the orientation-adjustment head being terminally connected to the orientation-adjustment male-threaded shaft;
the orientation-adjustment female-threaded nut being terminally engaged to the orientation-adjustment male-threaded nut, offset from the orientation-adjustment head;
the orientation-adjustment washer being pressed against the first wing plate by the orientation-adjustment head; and
the orientation-adjustment female-threaded nut being pressed against the second wing plate.

5. The gate protecting device as claimed in claim 3 comprising:
each of the plurality of orientation-adjustment fasteners comprising an orientation-adjustment hole, an orientation-adjustment head, an orientation-adjustment male-threaded shaft, an orientation-adjustment washer, and an orientation-adjustment female-threaded nut;
the orientation-adjustment hole traversing normal through the first wing plate, the U-shaped fitting, and the second wing plate;
the orientation-adjustment male-threaded shaft being positioned through the orientation-adjustment washer and the orientation-adjustment hole;
the orientation-adjustment head being terminally connected to the orientation-adjustment male-threaded shaft;
the orientation-adjustment female-threaded nut being terminally engaged to the orientation-adjustment male-threaded shaft, offset from the orientation-adjustment head;
the orientation-adjustment washer being pressed against the second wing plate by the orientation-adjustment head; and
the orientation-adjustment female-threaded nut being pressed against the first wing plate.

6. The gate protecting device as claimed in claim 1 comprising:
the length-adjustable arm comprising a proximal arm piece, a distal arm piece, a fastener-receiving slot, and a plurality of length-adjustment fasteners;
the bottom plate face being terminally mounted to the proximal arm piece, offset from the distal arm piece;
the elongated mounting plate being terminally connected to the distal arm piece, offset from the proximal arm piece;
the fastener-receiving slot traversing normal through the distal arm piece;
the fastener-receiving slot being positioned along the distal arm piece;
the plurality of length-adjustment fasteners being mounted through the proximal arm piece; and
the plurality of length-adjustment fasteners being attached into the fastener-receiving slot.

7. The gate protecting device as claimed in claim 6 comprising:
each of the plurality of length-adjustment fasteners comprising a length-adjustment hole, a length-adjustment head, a length-adjustment male-threaded shaft, a length-adjustment washer, and a length-adjustment female-threaded nut;
the length-adjustment hole traversing normal through the proximal arm piece;
the length-adjustment male-threaded shaft being positioned through the length-adjustment washer, the length-adjustment hole, and the fastener-receiving slot;
the length-adjustment head being terminally connected to the length-adjustment male-threaded shaft;
the length-adjustment female-threaded nut being terminally engaged to the length-adjustment male-threaded shaft, offset from the length-adjustment head;
the length-adjustment washer being pressed against the proximal arm piece by the length-adjustment head; and
the length-adjustment female-threaded nut being pressed against the distal arm piece.

8. The gate protecting device as claimed in claim 1 comprising:
a plurality of post-mounting features; and
the plurality of post-mounting features being integrated along the elongated mounting plate.

9. A gate protecting device comprising:
a gate-resting plate;
a gate-receiving plate;
a gate-stopping plate;
a length-adjustable arm;
an elongated mounting plate;
a first wing plate;
a second wing plate;
a U-shaped fitting;
a plurality of orientation-adjustment fasteners;
the gate-resting plate comprising a top plate face and a bottom plate face;
the gate-receiving plate being connected adjacent to the gate-resting plate;
the gate-receiving plate being positioned at an obtuse angle with the gate-resting plate;
the gate-receiving plate being oriented away from the top plate face;
the gate-stopping plate being connected adjacent to the gate-resting plate, opposite to the gate-receiving plate;
the gate-stopping plate being positioned perpendicular to the gate-resting plate;
the gate-stopping plate being oriented away from the bottom plate face;
the bottom plate face being terminally mounted to the length-adjustable arm;
the elongated mounting plate being terminally connected to the length-adjustable arm, opposite to the gate-resting plate;
the length-adjustable arm being positioned parallel to the gate-receiving plate and the gate-stopping plate;
the elongated mounting plate being positioned perpendicular to the length-adjustable arm;
the first wing plate being connected adjacent to the gate-resting plate;
the second wing plate being connected adjacent to the gate-resting plate, opposite to the first wing plate;
the first wing plate and the second wing plate being positioned perpendicular to the gate-resting plate;
the first wing plate and the second wing plate being oriented away from the top plate face;
the U-shaped fitting being terminally connected to the length-adjustable arm, opposite to the elongated mounting plate;
the U-shaped fitting being sized to slidably fit into a space confined by the first wing plate, the second wing plate, and the gate-resting plate;
the U-shaped fitting being attached in between the first wing plate and the second wing plate by the plurality of orientation-adjustment fasteners; and
the plurality of orientation-adjustment fasteners being positioned offset amongst each other.

10. The gate protecting device as claimed in claim 9 comprising:
an overhang tab;
the overhang tab being connected adjacent to the gate-receiving plate, opposite to the gate-resting plate;
the overhang tab being positioned perpendicular to the gate-resting plate; and
the overhang tab being oriented away from the top plate face.

11. The gate protecting device as claimed in claim 9 comprising:
each of the plurality of orientation-adjustment fasteners comprising an orientation-adjustment hole, an orientation-adjustment head, an orientation-adjustment male-threaded shaft, an orientation-adjustment washer, and an orientation-adjustment female-threaded nut;
the orientation-adjustment hole traversing normal through the first wing plate, the U-shaped fitting, and the second wing plate;
the orientation-adjustment male-threaded shaft being positioned through the orientation-adjustment washer and the orientation-adjustment hole;
the orientation-adjustment head being terminally connected to the orientation-adjustment male-threaded shaft;
the orientation-adjustment female-threaded nut being terminally engaged to the orientation-adjustment male-threaded nut, offset from the orientation-adjustment head;
the orientation-adjustment washer being pressed against the first wing plate by the orientation-adjustment head; and
the orientation-adjustment female-threaded nut being pressed against the second wing plate.

12. The gate protecting device as claimed in claim 9 comprising:
each of the plurality of orientation-adjustment fasteners comprising an orientation-adjustment hole, an orientation-adjustment head, an orientation-adjustment male-threaded shaft, an orientation-adjustment washer, and an orientation-adjustment female-threaded nut;
the orientation-adjustment hole traversing normal through the first wing plate, the U-shaped fitting, and the second wing plate;
the orientation-adjustment male-threaded shaft being positioned through the orientation-adjustment washer and the orientation-adjustment hole;
the orientation-adjustment head being terminally connected to the orientation-adjustment male-threaded shaft;
the orientation-adjustment female-threaded nut being terminally engaged to the orientation-adjustment male-threaded shaft, offset from the orientation-adjustment head;
the orientation-adjustment washer being pressed against the second wing plate by the orientation-adjustment head; and
the orientation-adjustment female-threaded nut being pressed against the first wing plate.

13. The gate protecting device as claimed in claim 9 comprising:
the length-adjustable arm comprising a proximal arm piece, a distal arm piece, a fastener-receiving slot, and a plurality of length-adjustment fasteners;
the bottom plate face being terminally mounted to the proximal arm piece, offset from the distal arm piece;
the elongated mounting plate being terminally connected to the distal arm piece, offset from the proximal arm piece;
the fastener-receiving slot traversing normal through the distal arm piece;
the fastener-receiving slot being positioned along the distal arm piece;
the plurality of length-adjustment fasteners being mounted through the proximal arm piece; and
the plurality of length-adjustment fasteners being attached into the fastener-receiving slot.

14. The gate protecting device as claimed in claim 13 comprising:
each of the plurality of length-adjustment fasteners comprising a length-adjustment hole, a length-adjustment head, a length-adjustment male-threaded shaft, a length-adjustment washer, and a length-adjustment female-threaded nut;
the length-adjustment hole traversing normal through the proximal arm piece;
the length-adjustment male-threaded shaft being positioned through the length-adjustment washer, the length-adjustment hole, and the fastener-receiving slot;
the length-adjustment head being terminally connected to the length-adjustment male-threaded shaft;
the length-adjustment female-threaded nut being terminally engaged to the length-adjustment male-threaded shaft, offset from the length-adjustment head;
the length-adjustment washer being pressed against the proximal arm piece by the length-adjustment head; and
the length-adjustment female-threaded nut being pressed against the distal arm piece.

15. The gate protecting device as claimed in claim 9 comprising:
a plurality of post-mounting features; and
the plurality of post-mounting features being integrated along the elongated mounting plate.
